(19) United States
(12) Patent Application Publication
(10) Pub. No.: US 2010/0166285 A1
(43) Pub. Date: Jul. 1, 2010

(54) SYSTEM AND METHOD FOR ACQUIRING IMAGE DATA

(75) Inventors: Jens-Peter Schlomka, Hamburg (DE); Axel Thran, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/377,145

(22) PCT Filed: Aug. 7, 2007
(86) PCT No.: PCT/IB07/53111

§ 371 Date: Feb. 11, 2009

(30) Foreign Application Priority Data
Aug. 11, 2006 (EP) 06118842.1

(51) Int. Cl. G06K 9/00

(52) U.S. Cl. 382/132

(57) ABSTRACT

According to an exemplary embodiment an imaging system (100) for examining an object under examination comprises a scanning unit, wherein the scanning unit comprises a radiation source (106, 108), and a detection unit (107, 109), wherein the scanning unit is adapted to emit a radiation beam (123), which radiation beam follows a linear movement of the object under examination such that a predetermined region of the object under examination is scanned while the object under examination moves.

### FIELD OF THE INVENTION

The invention relates to a system and a method for acquiring image data, a computer readable medium and a computer program. In particular, the invention relates to a cone-beam Computer Tomography system for baggage inspection having a high baggage throughput.

### BACKGROUND OF THE INVENTION

Systems for producing an image of a physical object are widespread in several technical fields. One area of particular commercial interest is that of fast baggage scanners that can be used in a number of instances, but are often particularly used to scan airline baggage. Another area of particular commercial interest is in the field of medical scanners. Beside the already known and widespread Computer Tomography (CT) devices a relatively new field of so-called Scattering Computer Tomography devices as well as of diffractive scanning units is developing.

For medical use as well as for baggage inspection, attenuation of transmitted radiation, not scattering, is generally used in commercial Computer Tomography (CT) scanners and C-arm systems. These systems use a variety of calculation techniques to calculate from measured X-ray data the X-ray attenuation properties of the sample at different locations in the sample, rather than simply provide an X-ray image of the sample as in conventional X-ray imaging.

For example, WO 2006/027756 discloses that the interaction of X-ray photons with matter in a certain energy range between 20 and 150 keV for instance, can be described by photoelectric absorption and scattering. Two different types of scattering exist: incoherent or Compton-scattering on the one hand, and coherent or Rayleigh-scattering on the other hand. Whereas Compton-scattering varies slowly with angle, Rayleigh-scattering is strongly forward directed and has a distinct structure, characteristic of each type of material. Furthermore, coherent X-ray scattering is a common technique or tool used in X-ray crystallography or X-ray diffraction when analyzing the molecular structure of materials in the semiconductor industry. The molecular structure function obtained provides a fingerprint of the material and allows good discrimination. For example, plastic explosives can be distinguished from harmless food products.

Although Coherent Scattering Computer Tomography (CSCT) is a very promising technique, problems exist when applying it to the field of baggage inspection. For example, such applications place stringent and demanding requirements in relation to throughput, dark alarms and findings.

Hence there is a desire to improve upon known CT/CSCT systems and methodologies.

### SUMMARY OF THE INVENTION

According to a first aspect of the invention, an imaging system for examining an object under examination is provided, comprising a scanning unit, wherein the scanning unit comprises a radiation source, and a detection unit, and wherein the radiation source of the scanning unit is adapted to emit a radiation beam, which follows a linear movement of the object under examination such that a predetermined region of the object under examination is scanned while the object under examination moves.

According to a second aspect of the invention, a method for acquiring image data of an object under examination is provided, which method uses an imaging system which comprises a scanning unit, wherein the scanning unit comprises a radiation source, and a detection unit, the method comprises following a linear movement of the object under examination with the radiation of the radiation source such that a predetermined region of the object under examination is scanned while the object under examination moves linearly, and acquiring image data indicative of the object under examination while the radiation of the radiation source follows the linear movement of the object under examination.

According to a further aspect of the invention, a computer readable medium is provided in which a program for acquiring image data of an object under examination is stored, which program, when executed by a processor, causes said processor to carry out a method aspect of the invention.

According to yet a further aspect of the invention, a computer program for acquiring image data of an object under examination is provided, which program, when executed by a processor, causes said processor to carry out a method aspect of the invention.

In an embodiment an imaging system for examining an object under examination is provided which imaging system comprises one scanning unit comprising a radiation source and an detection unit, wherein the radiation source is adapted to follow a linear movement of the object under examination, e.g. a baggage piece, like a bag or a suitcase. In particular, the term following means that the radiation emitted by the radiation source may be controlled such that the radiation beam always impinges or intersects the same region in the bag although the bag is moved in a linear manner, for example on a transport belt or a conveyor belt of a baggage scanner known in the field of security checking of baggage pieces on an airport. In particular, the radiation beam direction always crosses or scatters at the same predetermined region in the scanned baggage.

The using of at least one scanning unit which is able to follow a bag may increase the throughput in order to fulfil system requirements of an increased number of bags per hour, which requirements may not allow the stopping of the bag for further inspection of false alarms, but may instead requires so-called “on the fly” alarm resolution. By using a three-dimensional imaging system according to the exemplary embodiment the known baggage inspection may be simplified. In particular, the throughput may be increased due to the fact that the baggage may not be stopped during scanning while still a longer period of scanning may be performed than in the case of conventional system in which the scanning unit, i.e. the direction of the radiation emitted by a radiation source of the scanning unit, does not follow the baggage in its linear movement.

In the following, further embodiments of the aforementioned aspects of the invention will be described.

In an embodiment the imaging system further comprises a pre-scanning unit, the pre-scanning unit comprises a further radiation source and a further detection unit, wherein the pre-scanning unit is adapted to acquire a first data set indicative of a three-dimensional image of the object under examination.

For example, the pre-scanning unit may be a standard computer tomography device or another suitable device for acquiring data representing a three-dimensional image of the object under examination, like a scanning unit comprising several sub-scanning units arranged in such a manner that each of the sub-scanning units has an offset to each other so that the data sets of the sub-scanning unit at least represent quasi three-dimensional information, e.g. the sub-scanning units may have an offset of 30° to each other with respect to a rotation direction having a rotation axis parallel to the linear movement of the object under examination. The pre-scanning unit may also be called first scanning unit, while the scanning unit emitting a radiation beam wherein the scanning unit is adapted to follow a linear movement of the bag may also be called second scanning unit.

Thus, an imaging system having two scanning units may be provided, wherein one scanning unit is adapted to follow a linearly moved bag. Thus, the radiation beam emitted by the corresponding scanning unit may be move linearly at the same speed as an object under examination, leading to the fact that the scanning of the baggage piece may be done with a higher throughput while still having a sufficient time for an inspection of each baggage piece based on diffracting or scattering. By providing such a system having two scanning units and thus two radiation sources, e.g. X-ray tubes, and two detection units, e.g. X-ray detection units, it may be possible to use two different radiation sources, e.g. X-ray tubes which are tailored to specific different X-ray detection unit and/or detection principles. This tailoring may be in reference to the energy spectrum and/or radiation intensity.

By using such an imaging system the known baggage inspection may be simplified. In known baggage inspection devices according to the prior art a CT-scanner or CT system is used as a first level system, because of its high sensitivity and its possibility to acquire data representing a three-dimensional image. However, due to the low specificity of the result of such a conventional CT system a high number of false alarms are generated and thus further inspection is required. According to the prior art this is done by error-prone on-screen alarm resolution or hand inspections. Also, slow X-ray diffraction machines may be used in conventionally systems, which however may not fulfil the requirements of high throughput. By moving the radiation direction of the radiation of one scanning unit, so that the linear movement of the radiation matches the longitudinal movement of a baggage piece, as it is suggested by an embodiment of the present invention, the transport belt has not to be stopped during inspection such that the throughput may be increased by decreasing the holding time of the suspicious baggage in the imaging system according to an embodiment of the invention.

In an embodiment the imaging system further comprises a reconstruction unit and/or a determination unit, wherein the reconstruction unit is adapted to reconstruct a two- and/or three-dimensional image of the object under examination from the first data set, and wherein the determination unit is adapted to determine the predetermined region of the object under examination. For example, the predetermined region may be a suspicious region in a bag or suitcase. Furthermore, the determination unit may be adapted to determine whether the object under examination is to be scanned by the scanning unit at all according to a predetermined criterion based on the image reconstructed from the first data set acquired by the pre-scanning unit. Further, the reconstruction unit may also be adapted to reconstruct an image from data acquired by the detection unit of the scanning unit adapted to follow the linear movement of the bag, i.e. the second scanning unit.

Such reconstruction units are well known in the prior art and may be implemented as a computer or processor having suitable software implemented or may be provided in the form of suitable hardwired circuits. For example, suitable algorithm are known from

L. A. Feldkamp, L. C. Davis, and J. W. Kress, “Practical cone-beam algorithms”, J. Opt. Soc. Am. A 6, pp. 612-619, 1984, K. Taguchi, and H. Aradate, “Algorithm for image reconstruction in multi-slice helical CT”, Med. Phys. 25, pp. 550-561, 1998, and M. Grass, Th. Köhler, and R. Proksa, “3D cone-beam CT reconstruction for circular trajectories”, Phys. Med. Biol. 45, pp. 329-347, 2000.

For example, the determination unit may be adapted to determine whether a region of the object may show a doubtful, unclear, suspicious or potentially dangerous item. The criterion may be in particular set in order to distinguish between regions of different absorption of X-ray radiation, e.g. to distinguish between organic and metallic material. In a single-energy CT the distinction may be based on a reconstructed density of a region of the object under examination or on a linear attenuation coefficient. In a dual-energy CT the distinction may also be based on the so-called effective atomic number, which is described in detail in S. Naydenov, “Multi-energy radiography for non-destructive testing of materials and structures for civil engineering”, in Proceedings of the International Symposium on Non-Destructive Testing in Civil Engineering 2003, ISBN 3-931381, poster contribution P037.

In an embodiment of the imaging system the radiation source is an X-ray tube, and the detection unit is an X-ray detection unit, wherein the X-ray detection unit is adapted to acquire a second data set by detecting radiation emitted by the X-ray tube and after being scattered by the object under examination. Preferably, the scanning unit, i.e. the second scanning unit, comprises a diffraction detector unit.

Such a diffraction detector unit may be used for a scanning unit, which is simplified compared to a CSCT and which is also based on scattered radiation comprises a scanning unit having an X-ray tube and a corresponding diffraction detector unit, i.e. a detection unit which is adapted to detect radiation scattered by an object under examination, e.g. a suitcase. Contrary to a CSCT such a scanning unit is not adapted to acquire a data set by rotating the scanning unit around the object under examination, i.e. the scanning unit is not mounted on a rotatable gantry. Preferably, the second X-ray tube may be adapted to generate a so-called pencil-beam, while the second detection unit may be of a diffraction set-up. Preferably, the X-ray tube used for CSCT is a so-called high-power tube, i.e. exhibits higher radiation intensity than that required by the X-ray tube for the standard CT. In this application the term “standard CT” is used to describe a CT which comprises a scanning unit which is adapted to detect radiation which passed through the object under examination, i.e. a system in which the X-ray tube and the corresponding X-ray detection unit are arranged opposed to each other having the object under examination in between.

In an embodiment of the imaging system the first scanning unit comprises a first X-ray tube and a first X-ray detection unit, wherein the first X-ray detection unit is adapted to acquire a first data set by detecting radiation emitted by the first X-ray tube after passing the object under examination. That is, the first scanning unit may be formed by a scanning unit of a standard Computer Tomography system and may rotate around the object under examination.

Such a first scanning unit may exhibit a high throughput and may be in particular advantageous as a first level scanning unit for a baggage scanning system. The first data set may be used to determine regions in the baggage which might be suspicious and which may afterwards be scanned by the second scanning unit. Further, the first data set may be used to determine whether the baggage is to be scanned by the second scanning unit at all, i.e. in case no suspicious region is found in the baggage piece no scanning by the second scanning unit may be necessary so that the throughput may be increased.

For example, the first X-ray scanning unit comprises a plurality of detector elements, and/or the second X-ray scanning unit comprises a plurality of detector elements.

For example, the first X-ray detection unit may be formed by integrating detector elements, while the second one may be formed by energy-resolving detector elements. The first X-ray tube and the first X-ray detection unit may form the first scanning unit which may be adapted to perform standard Computer Tomography (CT).

In an embodiment the imaging system further comprises a guideway, wherein the scanning unit is adapted to be moved linearly along the guideway at a predetermined speed. That is, the second scanning unit may be adapted to be moved longitudinal along the guideway. For example, the predetermined speed corresponds to and/or equals the speed at which the object under examination is moved linearly. The scanning unit may be moved along the guideway in both or opposite ways, i.e. forwards and backwards, with respect to the moving object under examination.

Providing a guideway, along which the second scanning unit may be moved, may be an efficient way to provide a possibility to move the second scanning unit together with the moving object under examination.

In an embodiment the imaging system further comprises a transport mechanism, wherein the transport mechanism is adapted to transport the object under examination. This transport mechanism may be a conveyor belt or transport belt, for example. For example, the transport mechanism is adapted to transport the object under examination at a predetermined velocity, and the second scanning unit is adapted to be moved along the guideway at the same predetermined velocity. The adaptation of the second scanning unit to the velocity of the transport mechanism may be performed by adapting the scanning unit itself or by adapting the guideway, e.g. a motor may be implemented into the scanning unit or in the guideway which moves the scanning unit fixed to a moveable mounting along with the baggage on the transport mechanism.

By providing the possibility to move the object under examination and the second scanning unit at the same speed, it may be possible to simplify the scanning of the object since it may not necessary to stop the object, e.g. a bag, thus it may be possible to increase the throughput of the imaging system.

In an embodiment the imaging system further comprises a control unit, wherein the control unit is adapted to control the velocity of the transport mechanism and/or of the second scanning unit. The control unit and/or the second scanning unit and/or the guideway may as well be adapted that the second scanning unit may be moved backwards, i.e. against the movement direction of the object on the transport mechanism. Thus, it may be possible to use the scanning unit again for a next object under examination. In particular, the control unit may be adapted to move the second scanning unit synchronously with the object under examination.

In an embodiment the imaging system further comprises a plurality of scanning units, and a plurality of guideways, wherein each of the plurality of guideways is adapted to receive a respective one of the plurality of scanning units in a moveable manner.

For example, by providing a plurality of second scanning unit, each of which may be formed as a coherent scattering detection unit or having a diffractive scattering detection unit, it may be possible to provide a three-dimensional imaging system which has a higher throughput, since a plurality of second scanning units may be used in a consecutive way. That is, a first suspicious object, i.e. a bag, or region of the first bag is scanned using a first second scanning unit, while a second scanning unit may be used to scan a second suspicious object or a second region of the second object. Second scanning units which are not in use for scanning objects may be transported backwards, i.e. opposite to the moving direction of the object under examination, so that they may be used for the examination of further objects. For allowing this, preferably each of the plurality of second scanning units is adapted to be moved along the guideway at the predetermined velocity. In particular, the scanning units and/or the control unit may be adapted to move simultaneously with the object under examination, i.e. in a manner that each second scanning unit, during scanning, always is directed to the same region of the object to be scanned, in particular a suspicious region of the object under examination. For example, each of the plurality of second scanning units may be adapted in the same way as described above in connection to the firstly described second scanning unit. Furthermore, the second scanning units and/or the control unit may be adapted that each of the second scanning units may be moveable independently.

In an embodiment of the imaging system the plurality of second scanning units are displaced relative to each other. For example, the displacement is in the Φ-direction. The displacement in Φ-direction may be between 30° and 120°, preferably the displacement is substantially 45°. That is, the second scanning units may be displaced with respect to each other, in particular in relation to the moving direction of the second scanning units, i.e. they can be moved independently. Preferably, the so-called Φ-direction is the direction which is perpendicular to the moving direction and which direction corresponds to the Φ-direction in case the imaging system is described using cylindrical coordinates. The Φ-direction may in particular the direction in which the first scanning unit, e.g. a standard CT scanning unit rotates around the object under examination or the transport mechanism.

By providing the guideways having such a Φ-direction displacement a number of second scanning unit may be provided which can be easily moved independently from each other. On each one of these guideways preferably only one second scanning unit is arranged, so that a real independent moving is possible. However, it may also be possible to provide several second scanning units on one of the guideways, in order to increase the throughput. In this case the control unit is preferably adapted to ensure that the movement of the scanning units arranged on one guideway is not interfering. For example, the different second scanning units on one guideway are used in a consecutive sequence for scanning the object and are only transported back to their respective starting points in case all second scanning units on the respective guideway have been used to scan an object and reached their respective end positions on the respective guideway. In particular, the second scanning unit is adapted to be moveable along the respective guideway in two opposite directions so that the second scanning units can be moved back to their respective start-point.

In an embodiment of the imaging system the displacement is in a radial direction with reference to the rotation. This direction is in general called radial direction or r-direction in the coordinate system of cylindrical coordinates. When using such a radial displacement of the second scanning units the scanning units have different distances relative to the object under examination. This may lead to the advantage that more second scanning units and respective guideways may be arranged thus leading to an increased number of second scanning units and to an increased throughput.

In an embodiment of the imaging system the radiation source of the scanning unit is adapted that a radiation beam of the scanning unit is rotatable or tiltable. For example, the radiation direction of a pencil beam of the radiation source may be turned or moved like a wiper. For example, the radiation beam of the source may be rotatable or tiltable from −60° to +60° relative to a direction perpendicular to the movement direction of the object under examination, preferably from −45° to +45°. The rotation of the beam may be performed by tilting the radiation source itself or by moving a pencil beam steering collimator. For example, the imaging system further comprises a control unit, wherein the control unit is adapted to rotate or tilt the radiation source of the scanning unit or the pencil beam steering collimator such that the radiation of the radiation source scans the predetermined region of the object under examination. The control unit may also be called an angle control unit. The angle control unit may turn or tilt the radiation source such that the radiation impinges the predetermined region, i.e. a suspicious region in the object or bag. For example, the angle control unit may turn the radiation source at an angle velocity which is dependent on the velocity of the linear movement of the object under examination so that always the same region is scanned, while the radiation source does not moves linearly as the object under examination does.

In an embodiment the imaging system further comprises a guideway, wherein the detection unit of the scanning unit is attached in a moveable manner on the guideway. For example, the detection unit of the scanning unit is moveable such that it follows the radiation of the radiation source during the rotation or tilt of the rotation source.

By providing such a moveable detection unit of the scanning unit, i.e. the second scanning unit, it may be possible to provide an efficient way to use a relatively small detector unit having a small detecting or sensitive area while still be able to detect the scattered or diffracted radiation while the radiation beam follows the linear movement of the object under examination. According to this alternative an application of a stationary or almost stationary system to a moving object may be provided. No heavy parts of the system may need to be moved and accelerated which may increase lifetime of the equipment and may thus reduce operating costs.

In an embodiment of the imaging system the detection unit of the scanning unit is shiftable in a direction substantially perpendicular to linear movement of the object under examination.

By providing a shiftable detector which is shiftable substantially perpendicular to the moving direction of the object it may be possible to ensure that the radiation beam which intersects the region of interest in the bag may always impinges the detection unit independent of a position the object under examination is arranged on a transport belt.

Alternatively, the detection unit may have a dimension which is sufficient so that the radiation beam of the radiation source impinges the detection unit along the whole rotation or tilt of the radiation source. That is, the detection unit may have such a dimension that no movement of the detection unit is necessary in order to detect the radiation scattered by the object under examination independent of direction of the pencil beam, while the pencil beam follows the object or a specific region in the object under examination.

In an embodiment a proposed baggage scanner comprises a CT part with an X-ray tube and a CT detector and of a number of diffraction units on the downstream side from the CT scanner, which diffraction units can travel along with the baggage, e.g. a bag, during measurement and thus the bag does not need to be stopped. During one or more diffraction units are in operation, the other unused diffraction units can travel back to the starting point. This may allow continuous operation even if more than one suspicious region is found in a bag. Thus, it may be possible that only in extreme situations one bag needs to be rescanned, which may lead to an increase of the throughput of the baggage scanner while possibly still providing a very good detection rate and low false alarm rate. According to an embodiment a baggage scanning system may comprise a two-level system consisting of a fast cone-beam CT scanner and a number of secondary moveable inspection units based on X-ray diffraction technology for the further inspection of regions marked as suspicious by the cone-beam CT scanner. The secondary moveable inspection units may move at the same speed as the baggage during inspection by a Coherent Scattering Computer Tomography or pencil-beam diffraction set-up, for example. Thus, a really fast CT system may be provided which has the detection capability of a combined CT/CSCT scanning system. By using two different X-ray tubes for the first and the second scanning units, each may be tailored to the specific application. Furthermore, by using two different X-ray tubes it may be possible to tailor both to different collimation, one adapted to CT and one adapted to CSCT or diffractive detection which are in general different. Typical scatter angles in the diffractive scanning unit may be between 1° and 5°. The CT tube may have a tungsten anode spectrum while the acceleration voltage may be between 140 kV and 180 kV by a typical power between 2 kW and 3 kW. Additionally a 2 mm aluminium filter and possibly a 0.5 mm to 1 mm Cu filter may be used. The collimation may be adapted to form a fan beam or a cone beam depending on the used detector units. The focal spot of the radiation source may be about several mm wide and high.

Also the different optimal X-ray spectra and power requirements for the CT and CSCT system may be easily taken into account by using two X-ray tubes. Furthermore, geometrical limitation, e.g. a very closely mounting of the two X-ray detection units, which may be imposed on the mounting of the scattering detectors in such a system having only one X-ray tube may be overcome by using two different X-ray tubes as proposed by an embodiment of the present invention.

Such a system and the corresponding method may be used in the medical field, e.g. as an add-on for standard CT, but may be in particular useful in the field of baggage inspection, which is one of a fast growing sectors in the security field. An important advantage of a three-dimensional imaging system according to an embodiment may be to design a scanner, i.e. scanning system, which fulfils throughput requirements and at the same time may maintain a very good detection rate and a low false alarm rate. Since the bag can be transported on one single belt during CT scan and diffraction scan, no registration issues may occur and thus reliable and fully automatic operation may become possible. Since only one rotating gantry and rather small energy-resolving detectors are required, in particular as diffraction detection units, the machine may be less expansive than a CT/CSCT scanner.

In an embodiment a diffractive scanning unit may be introduced downstream from a CT-scanner, which diffractive scanning unit generates a scanning pencil beam pointed and moved such that it intersects with a region-of-interest (ROI) inside a bag during the entire movement of the bag through the diffractive sub system. On the opposite side of the baggage transport tunnel a scatter detector is positioned, which records the scattered radiation. The scatter detector may either be large and thus does not need to be moved for scanning or it may be a smaller one and thus needs to be moved during scanning. Since the bag is moved during scanning, only the ROI may be permanently in the beam whereas surrounding material may only be in the beam for a short time and thus may not produce a significantly structured background. Reconstruction methods based on tomosynthesis may be applied to possibly get an even better picture of the scatter properties of the ROI. As an additional feature, a secondary collimator may be placed in front of the scatter detector and may be moved and rotated such that the viewing direction of the detector always intersects with the primary beam at the ROI within the object.

These and other aspects of the invention will be apparent from and elucidated with reference to the embodiments described hereinafter.

### BRIEF DESCRIPTION OF DRAWINGS

Embodiments of the present invention will now be described, by way of example only, and with reference to the following drawings.

FIG. 1 shows a simplified schematic side-view of a geometry for a Computer Tomography system according to an embodiment;

FIG. 2 shows a simplified schematic cross-section of the Computer Tomography system of FIG. 1;

FIG. 3 shows a simplified side view of a scanning unit according to another embodiment;

FIG. 4 shows a simplified side view of the scanning unit of FIG. 3 which is turned by 90° with respect to FIG. 3; and

FIG. 5 shows a simplified top view of the scanning unit of FIG. 3.

### DETAILED DESCRIPTION OF EMBODIMENTS

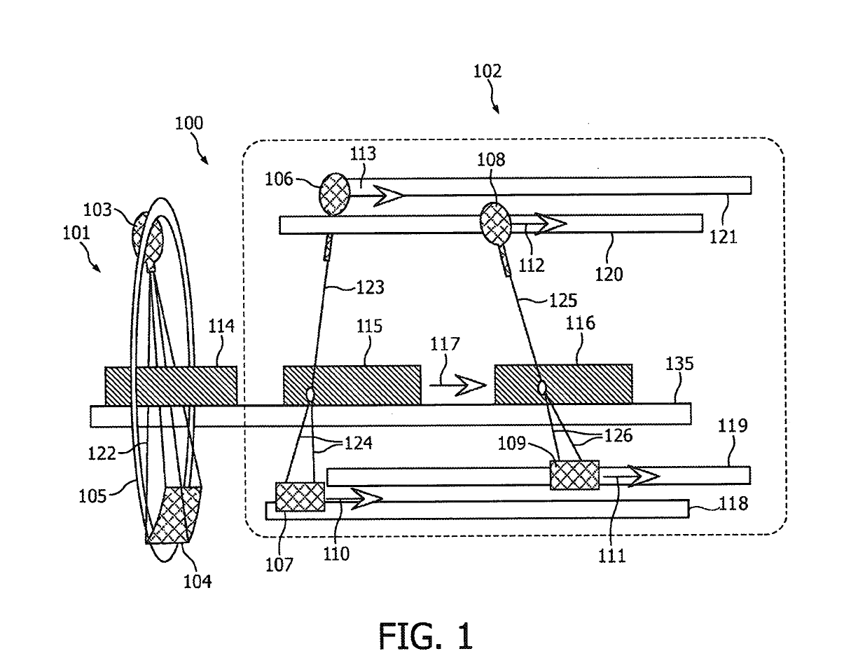

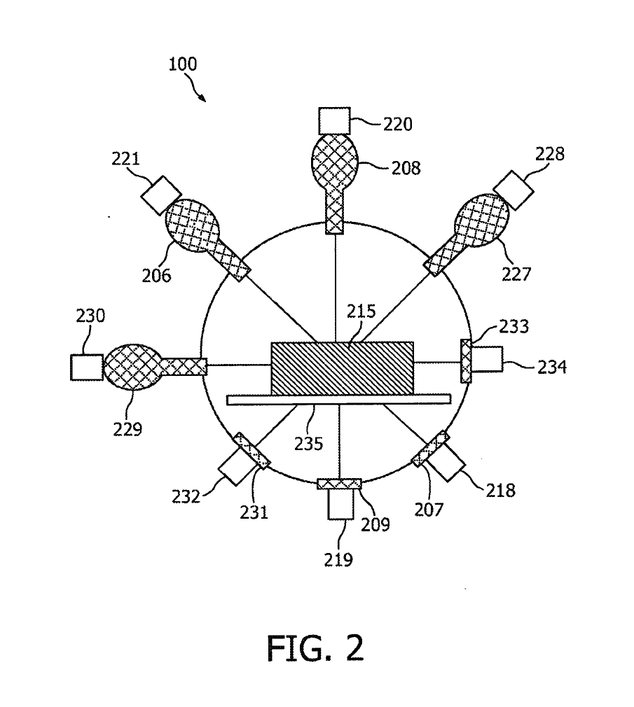

FIG. 1 shows a simplified schematic side-view of a geometry for a Computer Tomography system 100 according to an embodiment. The CT system 100 comprises a first scanning unit 101 or pre-scanning unit and a second region 102. The first scanning unit 101 comprises a first X-ray tube 103 and a first detection unit 104 which are arranged opposite to one another with respect to an object under examination, e.g. a bag 114. According to the shown embodiment the first scanning unit is formed as a fast standard Computer Tomography scanning unit, e.g. a cone-beam CT unit, and comprises a gantry 105 on which the first scanning unit 101 is mounted, i.e. the first X-ray tube 103 and the first detection unit 104, in a way that they can rotate around the bag 114. The second region 102 comprises a first second scanning unit which is schematically shown having a first second X-ray tube 106 and a first second detection unit 107, which is formed as a diffraction detector. Furthermore, the second region 102 comprises a second scanning unit comprising a second X-ray tube 108 and a second X-ray detection unit 109, which is formed as a diffraction detector. The second scanning units are formed so as to be movable on a longitudinal direction, which movement is indicated by the arrows 110, 111, 112, and 113, which corresponds to the first second detection unit 107, the second detection unit 109, the second X-ray tube 108, and the first second X-ray tube 106, respectively. The scatter units may apply pencil beam geometry. Preferably, the second scanning units have different travel paths, such that the units can travel back and forth without interference. The respective arrangement is shown in greater detail in FIG. 2. The number of second scanning units may be greater than two, e.g. three, four, five up to any desired number. The scanning units, i.e. the respective tubes and detection units may be arranged on a respective guideway each or may be arranged so that more than one scanning unit is arranged on one guideway.

Furthermore, three baggage items, e.g. bags, are schematically shown in FIG. 1 as rectangles labelled 114, 115, and 116 respectively, which are moved by a transport belt 135. This movement is indicated by arrow 117. The second region 102 comprises further four guideways 118, 119, 120, and 120 which are used to move the first second detection unit 107, the second detection unit 109, the second X-ray tube 108, and the first second X-ray tube 106, respectively.

Furthermore, radiation emitted by the first X-ray tube 103 is schematically shown by lines 122, while the corresponding radiation emitted by the first second X-ray tube 106 is schematically shown by line 123 and the corresponding radiation emitted by the second X-ray tube 108 is schematically shown by line 125. The scattering of the emitted radiation of the X-ray tubes of the second scanning units is schematically depicted by the deviated lines 124 and 126, respectively.

Additionally, the Computer Tomography system 100 may comprise a control unit (not shown) which is adapted to control the respective movements of the transport belt 135 and the second scanning units along the guideways 118, 119, 120 and 120. The longitudinal movements of the scanning units, i.e. the first second X-ray tubes, the second X-ray tubes, the first second detection unit and the second detection unit are controlled such that respective regions in suspicious bags may be scanned, while these bags are moved by the transport belt.

FIG. 2 shows a simplified schematic cross-section of the Computer Tomography system 100 of FIG. 1 in the direction of the transport belt, i.e. the direction in which a transport belt 235 moves a baggage 215. In FIG. 2 four second scanning units are schematically depicted. The first second scanning unit comprises a first second X-ray tube 206, which is moveable on a first guideway 221, and a first second detection unit 207, which is moveable on a second guideway 218. The second scanning unit comprises a second X-ray tube 208, which is moveable on a third guideway 220, and a second detection unit 209, which is moveable on a fourth guideway 219. The third second scanning unit comprises a third second X-ray tube 227, which is moveable on a fifth guideway 228, and a third second detection unit 231, which is moveable on a sixth guideway 232. The fourth second scanning unit comprises a fourth second X-ray tube 229, which is moveable on a seventh guideway 230, and a fourth second detection unit 233, which is moveable on an eight guideway 234. All the scanning units are formed to be diffraction units. Preferably, the scanning units are adjustable individually, i.e. in particular with respect to the radiation direction of the tubes and the velocity, to allow scanning of any single point within a bag, e.g. a suspicious bag.

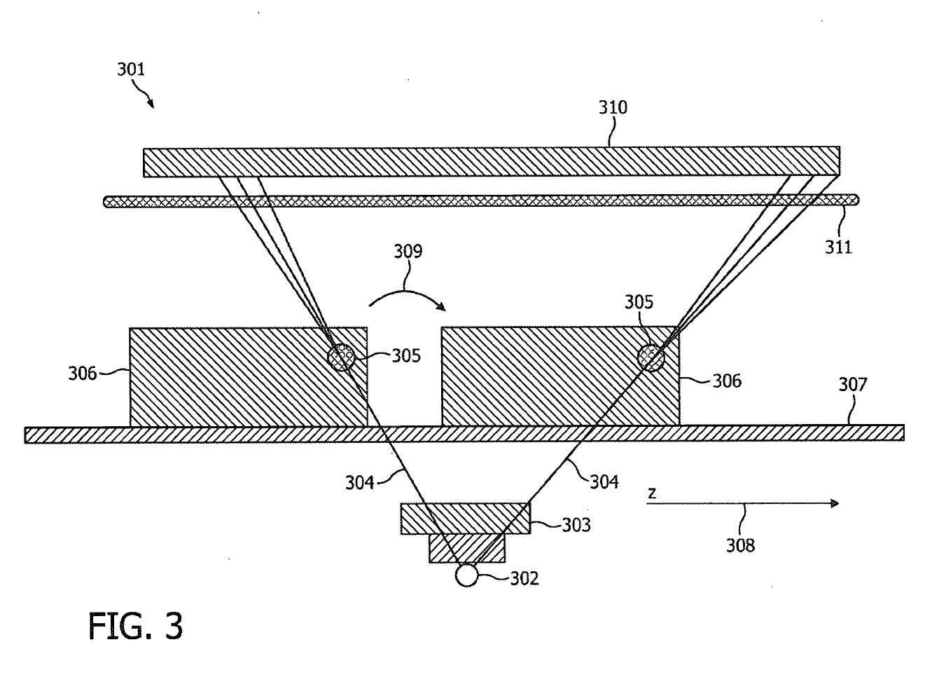

FIG. 3 shows a simplified side view of a set-up of a scanning unit according to another exemplary embodiment. In FIG. 3 only a scatter unit 301, i.e. the second scanning unit is shown. The second scanning unit 301 comprises an X-ray tube 302 having a two-dimensional pencil steering collimator 303 in front, i.e. above a tube exit window. The two-dimensional pencil steering collimator 303 operates in such a way that it rotates or turns a pencil beam, which is schematically shown by lines 304, like a wiper ensuring that a region-of-interest (ROI) 305 is in the beam during a passage of a suitcase 306. The suitcase 306 is positioned on a transport belt 307 which movement is schematically shown by the arrow 308 which also defines a z-direction. The rotation of the pencil beam 304 may be from −45° to 45° with respect to an axis perpendicular to the shown z-direction, i.e. with respect to an axis representing a y-direction which corresponds to a vertical axis in FIG. 3. By rotating the radiation beam by such an angle it may be ensured that the radiation beam always intersects the ROI. To illustrate this tilting the suitcase 306 is shown two times, i.e. at two positions of its movement, which movement is indicated by arrow 309. A detection unit 310 or detector is placed on top of the system. If the detector 310 is large, as shown in FIG. 3, no movement of the detector is necessary along the moving direction of the transport belt. However, the system may be equipped with a smaller detector, which then is moveable along the moving direction of the transport belt. The detector then has to move with a speed higher than the speed of the transport belt in order to ensure that the pencil beam always hits the detector during passage of the suitcase 306. Optionally the system 300 may be equipped with a beam stop 311 which may be used to shield the detection unit 310 from radiation which not relates to scattering at the ROI. The beam stop 311 may also be moveable along the movement direction of the transport belt and/or perpendicular to that direction. The scanner, i.e. the three-dimensional imaging system shown in FIG. 3 comprises a cone-beam CT (not shown) and one scatter unit. However, also more than one scatter unit may be applied. The scatter units apply pencil beam geometry, wherein the respective beam directions are different, such that all units may travel back and forth without interference.

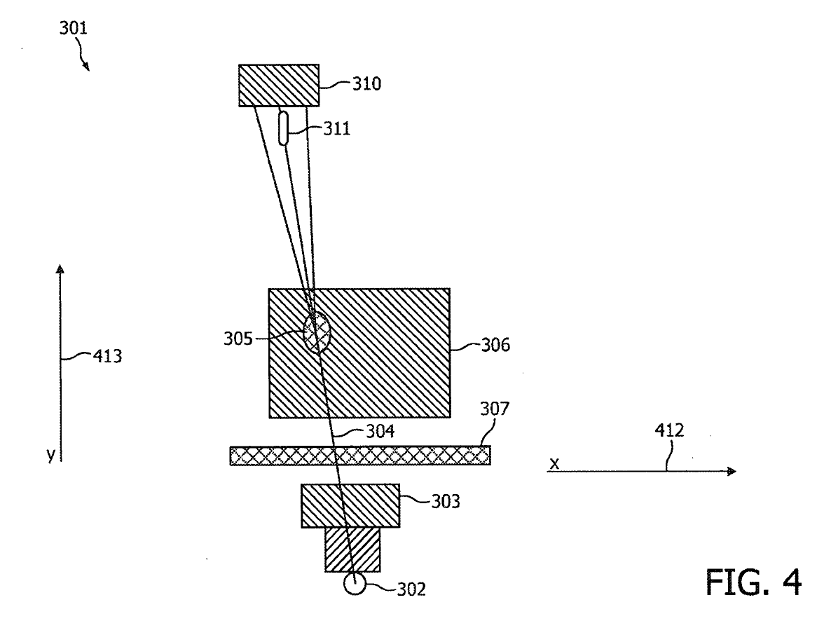

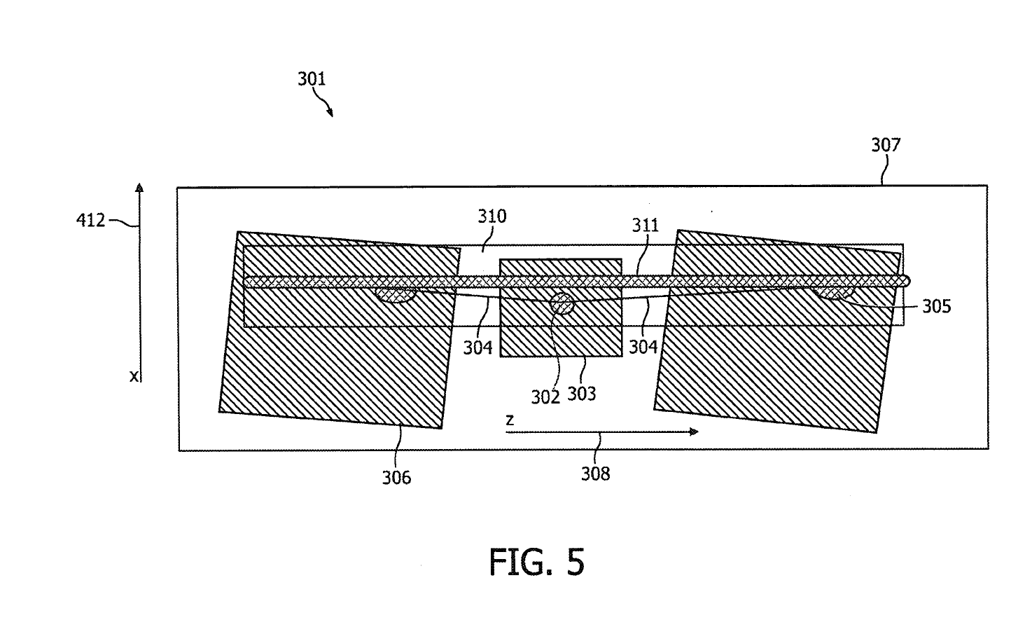

FIG. 4 shows a simplified side view of the scanning unit of FIG. 3 which is turned by 90° with respect to FIG. 3. In particular, FIG. 4 shows the system of FIG. 3 in a viewing direction in which the transport belt 307 moves out of the paper plane. FIG. 4 also shows the diffractive scatter unit 301 having the X-ray tube 302 including the two-dimensional pencil steering collimator 303 in front, i.e. above a tube exit window. The two-dimensional pencil steering collimator 303 positions the pencil beam 304 in such a way that it intersects the ROI 305 of the suitcase 306, which suitcase 306 is positioned on the transport belt 307 which, in FIG. 4, moves out the paper plane. Furthermore, the x-direction is indicated by arrow 412 while the y-direction is indicated by the arrow 413. The position perpendicular to the transport belt direction does not need adjustment during scanning because the suitcase does not move sideways. Furthermore, the detector 310 and the optional beam stop 311 are shown in FIG. 4 as well. The scatter detector can be as narrow as shown in FIG. 4 and afterwards in FIG. 5. It then has to be positioned along the x-direction when the suitcase of interest enters the scanning zone. Alternatively, a very large detector may be applied and thus no movement of the detector is necessary any more, neither in z-direction nor in x-direction. However, due to cost reasons it may be advantageous to use one or several small detector units, which are moveable along the x-direction and the z-direction. Preferably, all units or elements, in particular the scatter or diffractive scanning units are individually adjustable to allow scanning of any single point within a bag.

Contemporary X-ray detectors for such applications, e.g. based on CdZnTe, may be damaged or show reduced performance when hit by the directly transmitted radiation, i.e. the pencil beam. To prevent this the beam stop 311 may be used, which is preferably adjustable. It is positioned such that it blocks the pencil beam from directly reaching the detector. If the beam stop is realized as a long stripe, as shown in FIG. 3, it may only need to be adjusted along the x-direction when the suitcase enters the scanning zone.

FIG. 5 shows a simplified top view of the scanning unit of FIG. 3. FIG. 5 also shows the diffractive scatter unit 301 having the X-ray tube 302 including the two-dimensional pencil steering collimator 303 in front or on top, i.e. above a tube exit window. The two-dimensional pencil steering collimator 303 positions the pencil beam 304 in such a way that it intersects the ROI 305 of the suitcase 306, which suitcase 306 is positioned on the transport belt 307 which, in FIG. 5 moves along the z-direction. Furthermore, the x-direction is indicated by arrow 412 while the z-direction is indicated by the arrow 308. Furthermore, the detector 310 and the optional beam stop 311 are shown in FIG. 5 as well. As in FIG. 3 the suitcase 306 is shown in two different positions. Since a narrow detection unit 310 is used the detection unit 310 is shiftable along the x-direction to ensure that the X-ray beam intersecting the ROI 305 hits the detector at its centre.

The above description is made for a system having the X-ray tube underneath the transport belt. However, the set-up may also be positioned horizontally, i.e. the X-ray tube may be arranged to the left or the right of the transport belt, or even over the transport belt having the detection units underneath the transport belt.

Summarizing it may be seen as one aspect of the present invention that a combined Computer Tomography system is provided which comprises at least two scanning units, each comprising an X-ray tube and an X-ray detection unit, wherein the first scanning unit is adapted to perform a standard or transmitting Computer Tomography, while the second scanning unit is adapted to perform a coherently scattering or diffractive detection. In particular, the second scanning unit is adapted to emit a radiation beam which is moveable in the same direction as an object under examination travels. Such a combined Computer Tomography system may be used for material identification in the case of baggage inspection application and in medical applications for detection of diseases, which modify the molecular structure of tissue.

From reading the present disclosure, other variations and modifications will be apparent to the skilled person. Such variations and modifications may involve equivalent and other features which are already known in the art of X-Ray apparatus, baggage inspection and medical scanning, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, and reference signs in the claims shall not be construed as limiting the scope of the claims.

1. An imaging system (100) for examining an object under examination, the system (100) comprising:
a scanning unit, the scanning unit comprising;
a radiation source (106, 108); and
a detection unit (107, 109);
wherein the scanning unit is adapted to emit a radiation beam (123), wherein the radiation beam (123) follows a linear movement of the object under examination such that a predetermined region of the object under examination is scanned while the object under examination moves.

2. The imaging system (100) of claim 1, further comprising:
a pre-scanning unit (101), the pre-scanning unit (101) comprising:
a further radiation source (103); and
a further detection unit (104);
wherein the pre-scanning unit (101) is adapted to acquire a first data set indicative of a three-dimensional image of the object under examination.

3. The imaging system (100) according to claim 2, further comprising:
a reconstruction unit,
wherein the reconstruction unit is adapted to reconstruct an image of the object under examination from the first data set.

4. The imaging system (100) according to claim 1, further comprising:
a determination unit,
wherein the determination unit is adapted to determine the predetermined region of the object under examination.

5. The imaging system (100) according to claim 1,
wherein the radiation source (106, 108) is an X-ray tube; and
wherein the detection unit (107, 109) is an X-ray detection unit,
wherein the X-ray detection unit (107, 109) is adapted to acquire a second data set by detecting radiation emitted by the X-ray tube (106, 108) and after being scattered by the object under examination.

6. The imaging system (100) according to claim 1, further comprising:
a guideway (118, 119, 120, 121);
wherein the scanning unit is adapted to be moved linearly along the guideway (118, 119, 120, 121) at a predetermined speed.

7. The imaging system (100) according to claim 6, further comprising:
a control unit,
wherein the control unit is adapted to control the velocity of the scanning unit.

8. The imaging system (100) according to claim 7, further comprising:
a transport mechanism (135),
wherein the control unit is adapted to control the velocity of the transport mechanism.

9. The imaging system (100) according to claim 6, further comprising:
a plurality of scanning units, and
a plurality of guideways (118, 119, 120, 121),
wherein each of the plurality of guideways (118, 119, 120, 121) is adapted to receive a respective one of the plurality of scanning units in a linearly moveable manner.

10. The imaging system (100) according to claim 9,
wherein each of the plurality of scanning units are displaced relative to each other.

11. The imaging system (301) according to claim 1,
wherein the radiation source (302) is adapted that the radiation beam (304) of the scanning unit is tiltable.

12. The imaging system (301) according to claim 11, further comprising:
a control unit;
wherein the control unit is adapted to tilt the radiation source (302) of the scanning unit such that the radiation beam (304) of the radiation source (302) scans the predetermined region of the object under examination.

13. The imaging system (301) according to claim 11, further comprising:
a guideway;
wherein the detection unit (310) of the scanning unit is attached in a moveable manner on the guideway.

14. The imaging system (301) according to claim 13,
wherein the detection unit (310) of the scanning unit is moveable such that it follows the radiation of the radiation source (302) during the tilting of the radiation source (302).

15. The imaging system (301) according to claim 14,
wherein the detection unit (310) of the scanning unit is moveable in a direction substantially perpendicular to the linear movement of the object under examination.

16. The imaging system (302) according to claim 11,
wherein the detection unit (310) has a dimension which is sufficient so that the radiation of the radiation source (302) impinges the detection unit (310) along the whole tilting of the radiation source (302).

17. A method for acquiring image data of an object under examination using an imaging system (100) which comprises a scanning unit and a detection unit (107, 109), and wherein the scanning unit comprises a radiation source (106, 108), the method comprising:
following a linear movement of the object under examination with the radiation of the radiation source (106, 108) such that a predetermined region of the object under examination is scanned while the object under examination moves linearly; and
acquiring image data indicative of the object under examination while the radiation of the radiation source (106, 108) follows the linear movement of the object under examination.

18. A computer readable medium in or on which a computer program for acquiring image data of an object under examination is provided, the program performing the method of claim 17.

19. A computer program for acquiring image data of an object under examination, the program performing the method of claim 17.
